(19) United States
(12) Patent Application Publication
(10) Pub. No.: US 2006/0232124 A1
(43) Pub. Date: Oct. 19, 2006

(54) Device and method for braking a vehicle

(75) Inventors: Michael Friederich, Lorch (DE); Gerhard Weiss, Unteregg/Warmisried (DE)

Correspondence Address: FITCH, EVEN, TABIN & FLANNERY, P. O. BOX 65973, WASHINGTON, DC, 20035, US

(73) Assignee: DaimlerChrysler AG, Stuttgart (DE)

(21) Appl. No.: 10/559,458

(22) PCT Filed: May 28, 2004
(86) PCT No.: PCT/EP04/05775

§ 371 Date: Apr. 5, 2006

(30) Foreign Application Priority Data
Jun. 6, 2003 (DE) 103256504

(51) Int. Cl. B60T 13/74

(52) U.S. Cl. 303/3; 303/15

(57) ABSTRACT

The invention relates to a braking apparatus for a vehicle, having a first braking control device (6, 8, 9, 10, 15, 27) and a second braking control device (7, 16, 17, 18), in which case the vehicle can be braked both by operation of the first braking control device and by operation of the second braking control device. In order to carry out an automatic emergency braking process for the vehicle, the first braking control device interacts with a first evaluation unit (19), and the second braking control device interacts with a second evaluation unit (21), with the first evaluation unit (19) and the second evaluation unit (21) determining independently of one another whether the automatic emergency braking process should be carried out by operation of the respective braking control device, and the second evaluation unit (21) initiating the automatic emergency braking process when the first evaluation unit (19) and/or the first braking control device have/has a malfunction during operation.

The invention relates to a braking apparatus and a braking method for a vehicle. The braking apparatus has a first braking control device and a second braking control device, in which case the vehicle can be braked both by operation of the first braking control device and by operation of the second braking control device.

The Laid-Open Specification DE 198 26 687 A1 discloses a braking system for motor vehicles and a braking method for driving the braking system. The braking system comprises a first brake operating device and a second brake operating device, in which case the vehicle can be braked by the driver both by operation of the first brake operating device and by operation of the second brake operating device. It is thus possible to bring the vehicle safely to rest for example in the event of a failure of the first brake operating device by operation of the second brake operating device. Simultaneous action by an antilock braking system (ABS), an electronic stability program (ESP) or a braking assistant (BAS) can take place, if required, in conjunction with operation of the brake operating devices. No provision is made in this case for driver-independent operation of the brake operating devices when critical driving situations occur.

The object of the present invention is therefore to develop a braking apparatus and a braking method of the type mentioned initially, in such a way that the apparatus and the method are suitable for reliably carrying out an automatic emergency braking process for a vehicle when critical driving situations occur.

This object is achieved on the basis of the features of patent claim 1 and of patent claim 9, respectively.

For this purpose, the braking apparatus according to the invention for a vehicle has a first braking control device and a second braking control device, in which case the vehicle can be braked both by operation of the first braking control device and by operation of the second braking control device. The braking apparatus is designed in such a way that, in critical driving situations, in particular in which there is a risk of running into a preceding vehicle, the braking control devices can be operated independently of the driver, in the form of an emergency braking process that is carried out automatically. For this purpose, the first braking control device interacts with a first evaluation unit, and the second braking control device interacts with a second evaluation unit, with the first evaluation unit and the second evaluation unit determining independently of one another whether the automatic emergency braking process should be carried out by operation of the respective braking control device. The second evaluation unit initiates the automatic emergency braking process when the first evaluation unit and/or the first braking control device have/has a malfunction during operation. It is thus possible, despite a malfunction during operation of the first evaluation unit and/or of the first braking control device, to initiate and/or to carry out the automatic emergency braking process by driving the second braking control device in the intended manner. In order to preclude a possibly disturbing influence on the operation of the second evaluation unit and/or the second braking control device as a consequence of a malfunction during operation of the first evaluation unit and/or of the first braking control device, the first evaluation unit and/or the first braking control device can be switched off (“fail silent”). Only the faulty component is preferably switched off.

Advantageous embodiments of the braking apparatus according to the invention are specified in the dependent claims.

The first braking control device is advantageously a service brake, which is already provided in the vehicle. The service brake typically comprises wheel braking devices, which are associated with the vehicle wheels, a service brake controller for driving the wheel braking devices, and a brake operating element which can be operated by the driver and interacts with a service brake pressure sensor, by means of which the wheel braking devices can be driven to brake the vehicle via the service brake pressure sensor. The service brake controller may in this case carry out higher-level functions, such as that of an antilock braking system (ABS), an electronic stability program (ESP) or a braking assistant (BAS).

Furthermore, the second braking control device is advantageously a parking brake which is already provided in the vehicle. The parking brake typically comprises wheel braking devices which are associated with the vehicle wheels, and a parking brake operating element, which can be operated by the driver and interacts with a parking brake pressure sensor, by means of which the wheel braking devices can be driven to brake the vehicle and to secure the vehicle at rest via the parking brake pressure sensor. The wheel braking devices of the parking brake are preferably identical to those of the service brake in the vehicle.

The use of the service brake and/or parking brake which are already provided in the vehicle allows the braking apparatus according to the invention to be provided in a cost-saving manner, with the inclusion of proven and thus reliable brake components.

A malfunction during operation of the first evaluation unit, for example in the form of incorrectly produced drive signals for driving the first braking control device, and/or during operation of the first braking control device, for example in the form of a leakage in the hydraulic or pneumatic supply lines to the brake actuators and/or a faulty brake actuator, occurs in particular when the first evaluation unit initiates an automatic emergency braking process and the second evaluation unit determines that the first evaluation unit and/or the first braking control device is carrying out the automatic emergency braking process in an intended manner. Furthermore, the first evaluation unit has a malfunction during operation, for example in the form of faulty detection of the driving situation, when the second evaluation unit determines, in contrast to the first evaluation unit, that the automatic emergency braking process should be carried out. This makes it possible to detect in a simple manner all feasible malfunctions, which lead to incorrect carrying out and/or initiation of the automatic emergency braking process, during operation of the first evaluation unit and/or of the first braking control device.

The first evaluation unit advantageously determines on the basis of the satisfaction of at least one predetermined first initiation condition whether the automatic emergency braking process should be carried out. In a corresponding manner, the second evaluation unit uses the satisfaction of at least one predetermined second initiation condition to determine whether the automatic emergency braking process should be carried out. By appropriate choice of the initiation conditions, it is possible in particular to define the driving situations in which the automatic emergency braking process should be initiated.

In order to reduce the risk of spurious initiation of an automatic emergency braking process, it is feasible for the first evaluation unit to initiate the automatic emergency braking process only when the second evaluation unit additionally determines that a predetermined additional initiation condition is satisfied.

The braking apparatus according to the invention and the braking method according to the invention will be explained in more detail in the following text with reference to the attached drawings, in which:

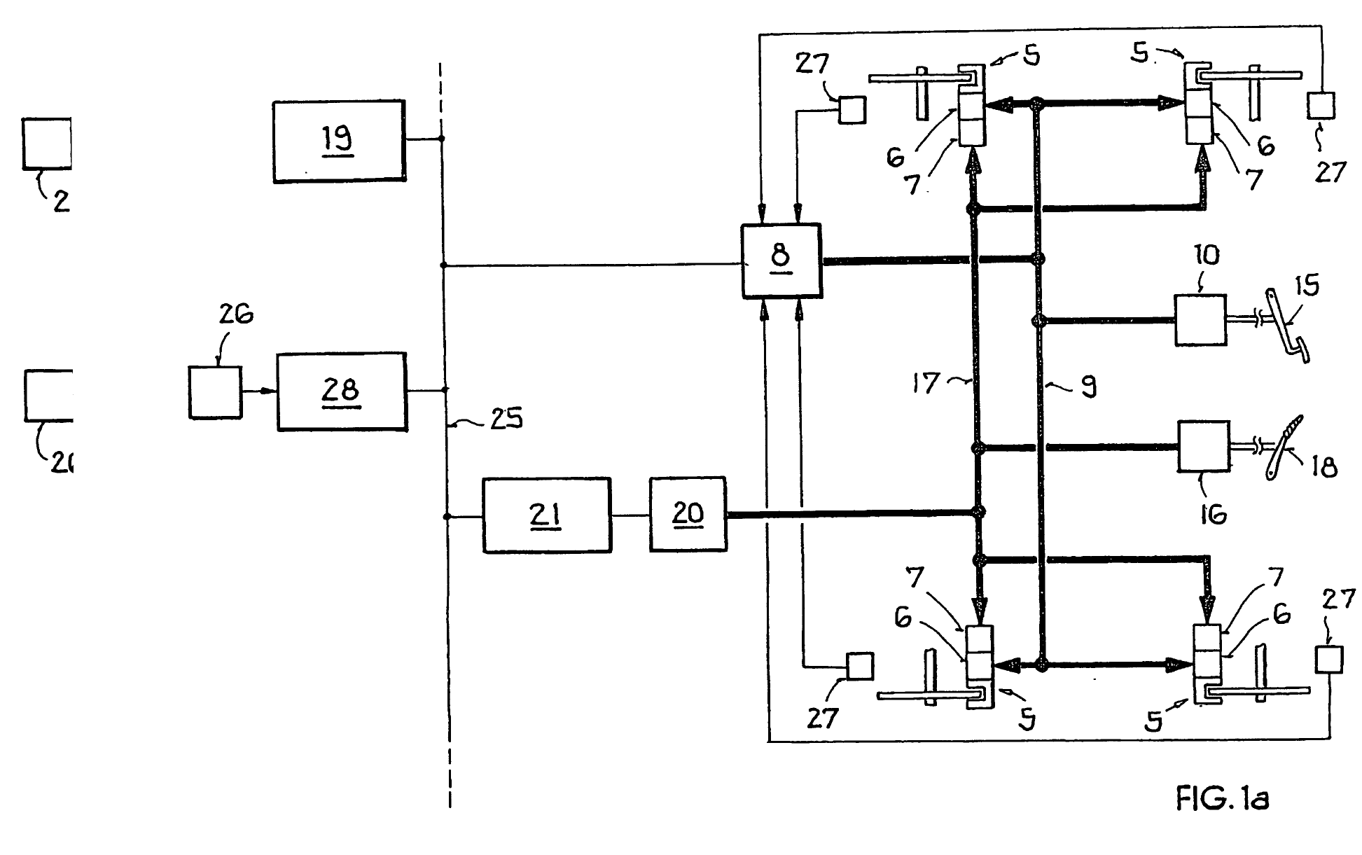

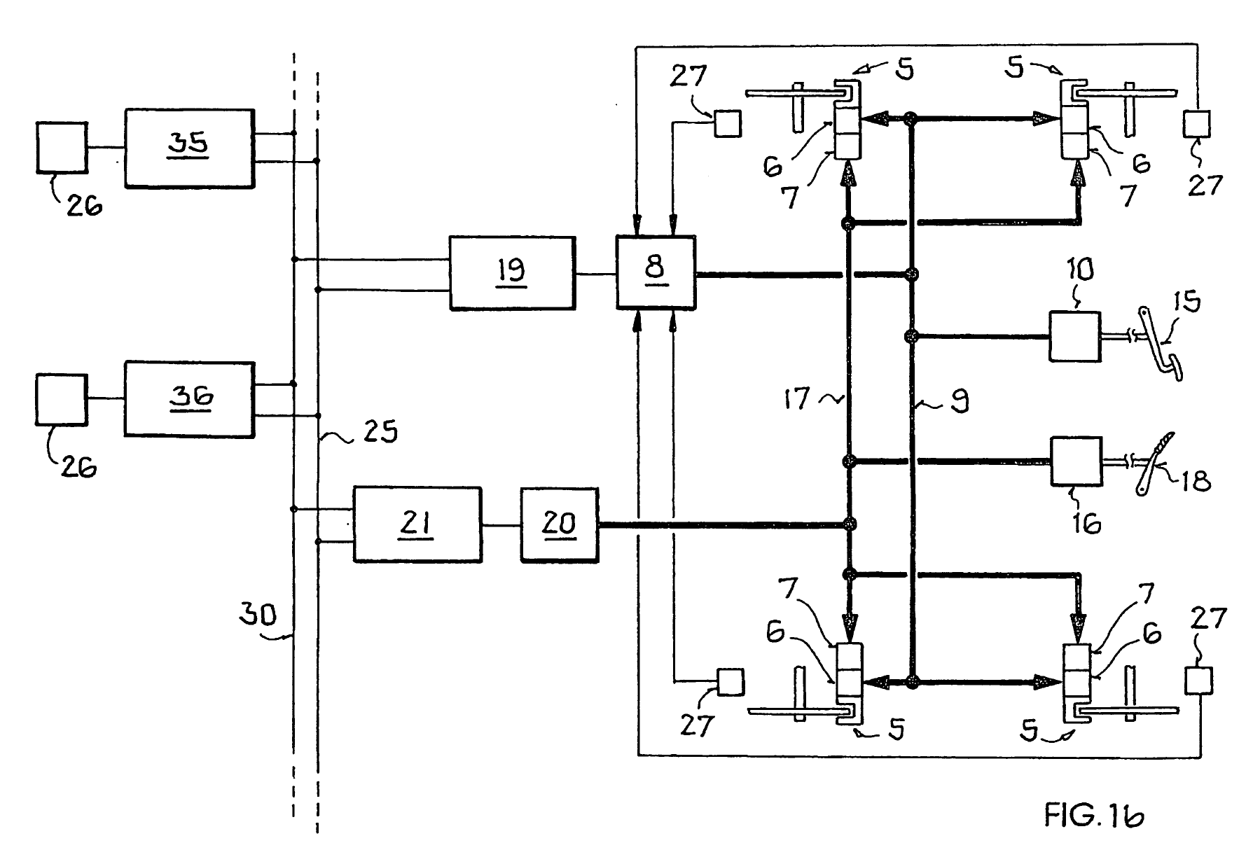

FIG. 1a shows a schematically illustrated first exemplary embodiment of the braking apparatus according to the invention,

FIG. 1b shows a schematically illustrated second exemplary embodiment of the braking apparatus according to the invention, and

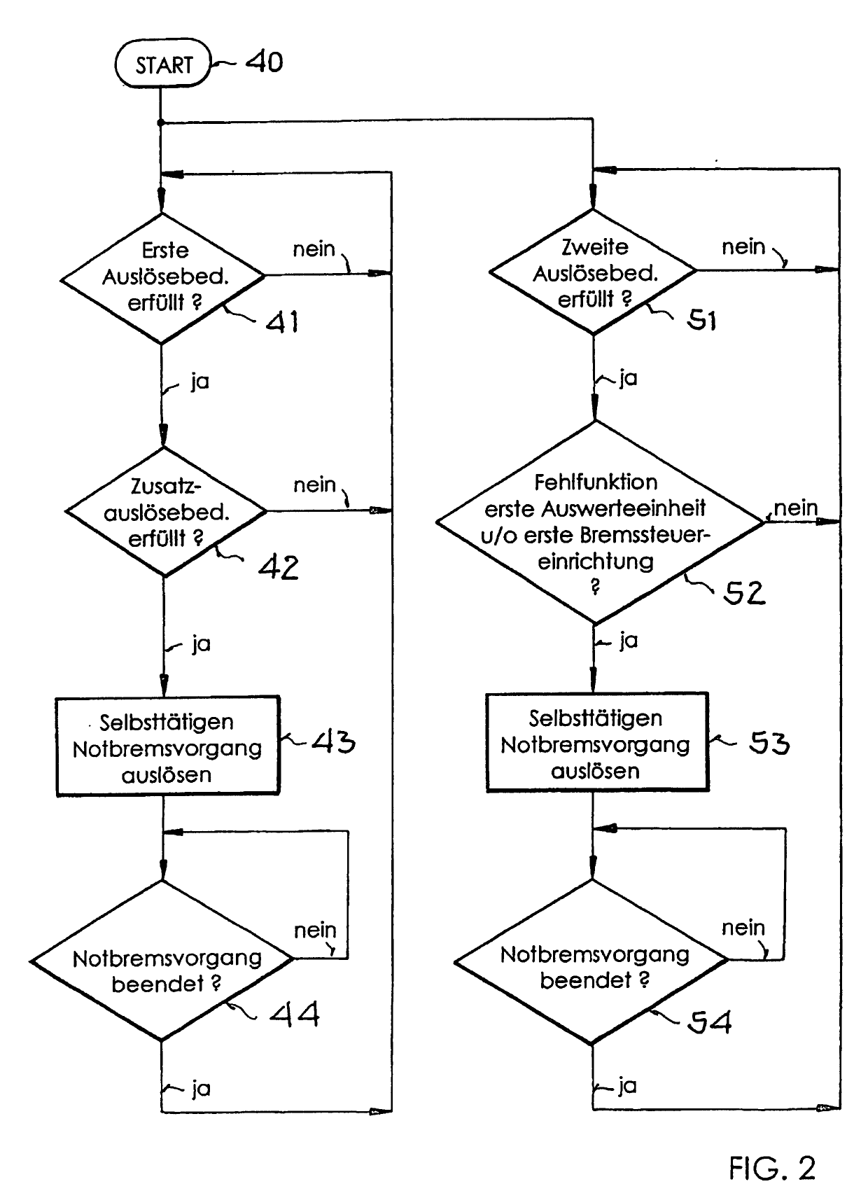

FIG. 2 shows an exemplary embodiment of the braking method according to the invention, in the form of a flowchart.

FIG. 1a shows a schematic illustration of a first exemplary embodiment of the braking apparatus according to the invention, having a first braking control device, comprising the components 6, 8, 9, 10, 15, 27, and having a second braking control device, comprising the components 7, 16, 17, 18. By way of example, the first braking control device is a service brake which is already provided in the vehicle, and the second braking control device is a parking brake which is already provided in the vehicle, with this being either a conventional, purely mechanical parking brake, or else a parking brake which can be driven electrically.

The service brake and the parking brake comprise joint wheel braking devices 5, which are associated with vehicle wheels, which are not illustrated. The wheel braking devices 5 have service brake actuators 6, which are intended for hydraulic or pneumatic drive purposes, and parking brake actuators 7, with the service brake actuators 6 being associated with the service brake, and the parking brake actuators 7 being associated with the parking brake of the vehicle.

Furthermore, the service brake comprises a service brake controller 8, which is connected to the service brake actuators 6 in order to drive the wheel braking devices 5 via service brake lines 9, and a brake operating element 15, which can be operated by the driver and interacts with a service brake pressure sensor 10, and by means of which the wheel braking devices 5 can be driven in order to brake the vehicle via the service brake pressure sensor 10, for which purpose the service brake pressure sensor 10 is connected to the service brake actuators 6 via the service brake lines 9. The service brake lines 9 and the service brake pressure sensor 10 are likewise a component of the service brake. The brake operating element 15 in the present exemplary embodiment is a brake pedal.

In a corresponding manner, the parking brake, which, in accordance with the following description, may be a conventional, mechanical parking brake, comprises not only the wheel braking devices 5 and the parking brake actuators 7 but also a parking brake operating element 18, which can be operated by the driver and interacts with a parking brake pressure sensor 16, by means of which the wheel braking devices 5 can be driven in order to brake the vehicle via the parking brake pressure sensor 16, for which purpose the parking brake pressure sensor 16 is connected to the parking brake actuators 7 via parking brake lines 17. The parking brake pressure sensor 16 and the parking brake lines 17 are likewise a component of the parking brake. The parking brake operating element 18 in the present exemplary embodiment is a parking brake lever, although a parking brake pedal can be provided just as well as the parking brake lever.

The vehicle can be braked equally well both by operation of the service brake and by operation of the parking brake, with the braking apparatus according to the invention being designed in such a way that, in critical driving situations in which, in particular, there is a risk of running into a preceding vehicle, the service brake or the parking brake is operated independently of the driver, in the form of an automatic emergency braking process. Instead of a preceding vehicle, this may, of course, also be any other stationary or moving object.

For this purpose, the service brake interacts with a first evaluation unit 19 via the service brake controller 8, and the parking brake interacts with a second evaluation unit 21 via a parking brake controller 20. The parking brake controller 20 may be a further component of the parking brake, which in this case can be driven electrically.

The service brake controller 8 and the first evaluation unit 19 are connected to one another via a CAN (control area network) bus system 25, which is provided in vehicles. The first evaluation unit 19 and the second evaluation unit 21 determine independently of one another whether the automatic emergency braking process should be carried out by operation of the service brake or of the parking brake. The second evaluation unit 21 initiates the automatic emergency braking process only when the first evaluation unit 19 and/or the service brake have/has a malfunction during operation.

In order to preclude a possible disturbing influence on the operation of the second evaluation unit 21 and/or of the parking brake in the event of a malfunction during operation of the first evaluation unit 19 and/or of the service brake, the first evaluation unit 19 and/or the service brake are/is optionally switched off (“fail silent”).

A malfunction during operation of the first evaluation unit 19 and/or of the service brake occurs, in particular, when the first evaluation unit 19 initiates an automatic emergency braking process and the second evaluation unit 21 determines that the first evaluation unit 19 and/or the service brake is carrying out the automatic emergency braking process in an unintended manner. Furthermore, the first evaluation unit 19 has a malfunction during operation when the second evaluation unit 21, in contrast to the first evaluation unit 19, determines that the automatic emergency braking process should be carried out.

The first evaluation unit 19 uses the satisfaction of at least one predetermined first initiation condition to determine whether the automatic emergency braking process should be carried out. In a corresponding manner, the second evaluation unit 21 uses the satisfaction of at least one second initiation condition to determine whether the automatic emergency braking process should be carried out. The first evaluation unit 19 preferably initiates the automatic emergency braking process only when the second evaluation unit 21 additionally determines that a predetermined additional initiation condition is satisfied.

The initiation conditions and the additional initiation condition include variables such as the speed of travel of the vehicle, the relative speed between the vehicle and a preceding vehicle, or the relative separation between the vehicle and a preceding vehicle. These variables can be derived from distance signals from a proximity sensor 26 and from wheel rotation speed signals from wheel rotation speed sensors 27 which are associated with the vehicle wheels.

The proximity sensor 26 is, for example, a component of a proximity cruise control (ART), which is already provided in the vehicle, for which purpose the proximity sensor 26 interacts with a proximity controller 28, which drives the service brake controller 8 and thus the service brake for the vehicle via the CAN bus system 25. In this case, the distance signal which is applied to the CAN bus system 25 and may be processed by the proximity controller 28 is made available to the first evaluation unit 19 and to the second evaluation unit 21. The proximity sensor 26 is, for example, a radar sensor or an ultrasound sensor.

The wheel rotation speed sensors 27 are connected directly to the service brake controller 8, which uses the wheel rotation signals to carry out higher-level functions, such as those for an antilock braking system (ABS), an electronic stability program (ESP) or a braking assistant (BAS). The service brake controller 8 provides the possibly processed wheel rotation signals via the CAN bus system 25 to the first evaluation unit 19 and to the second evaluation unit 21.

It is not intended to describe in any more detail here the mathematical and/or physical backgrounds to the initiation conditions or to the additional initiation condition, and in this context reference should be made in particular to the document DE 196 47 430 A1.

FIG. 1b shows a schematic illustration of a second exemplary embodiment of the braking apparatus according to the invention. The present exemplary embodiment differs from the previous exemplary embodiment primarily by the modified arrangement of the first evaluation unit 19 and by the presence of a further CAN bus system 30. The evaluation unit 19 is connected in series upstream of the service brake controller 8, starting from the two CAN bus systems 25, 30. Furthermore, a further proximity sensor 29 is provided in addition to the proximity sensor 26, with the proximity sensors 26, 29 interacting with a respective signal converter 35, 36, and with the signal converters 35, 36 providing the possibly processed distance signals from the proximity sensors 26, 29 in a redundant form via the CAN bus systems 25, 30 to the first evaluation unit 19 and to the second evaluation unit 21. Both the proximity sensors 26, 29 and the signal converters 35, 36 may be a component of a proximity cruise control (ART), which is already provided in the vehicle.

As a result of the modified arrangement of the first evaluation unit 19 and the redundant embodiment of the proximity sensors 26, 29, of the signal converters 35, 36 and of the CAN bus systems 25, 30, the braking apparatus now has a completely two-channel configuration, which ensures a further improvement in the operational reliability of the braking apparatus. The fundamental method of operation of the braking apparatus remains unaffected by this, so that reference should be made at this point to the description relating to FIG. 1a.

Finally, FIG. 2 shows an exemplary embodiment of the braking method according to the invention in the form of a flowchart. The braking method is started in a first main step 40 which, for example, is carried out by operation of a switch, which is arranged in the vehicle, by the driver. In a second main step 41, following this, a check is carried out to determine whether the first initiation condition, which is stored in the first evaluation unit 19, is satisfied. If this is the case, the process continues with a third main step 42. Otherwise, the procedure returns to the second main step 41 again. In the next, third main step 42, a check is carried out to determine whether the additional initiation condition, which is stored in the second evaluation unit 21, is satisfied. If this is satisfied, the first evaluation unit 19 initiates an automatic emergency braking process in a fourth main step 43, by operation of the vehicle service brake. If, on the other hand, the additional initiation condition is not satisfied, the procedure returns to the second main step 41 again. Finally, a check is carried out in a fifth main step 44 to determine whether the automatic emergency braking process has ended. If this is the case, the procedure returns to the second main step 41. Otherwise, the procedure returns to the fifth main step 44 until the automatic emergency braking process has ended.

In parallel with the procedure which is defined by the main steps 41 to 44, a check is carried out in a first auxiliary step 51 to determine whether the second initiation condition, which is stored in the second evaluation unit 21, is satisfied. If this is the case, the process continues with a second auxiliary step 52. If, on the other hand, the second initiation condition is not satisfied, the procedure returns to the first auxiliary step 51 again. A check is carried out in the subsequent second auxiliary step 52 to determine whether a malfunction has occurred during operation of the first evaluation unit 19 and/or of the vehicle service brake. If this is the case, an automatic emergency braking process is initiated by operation of the vehicle parking brake by the second evaluation unit 21 in a third auxiliary step 53. If, on the other hand, there is no malfunction, the procedure returns to the first auxiliary step 51 again. Finally, a check is carried out in a fourth auxiliary step 54 to determine whether the automatic emergency braking process has ended. If this is the case, the procedure returns to the first auxiliary step 51. Otherwise, the procedure returns to the fourth auxiliary step 54 until the automatic emergency braking process has ended.

1. A braking apparatus for a vehicle, having a first braking control device (6, 8, 9, 10, 15, 27) and a second braking control device (7, 16, 17, 18), in which case
the vehicle can be braked both by operation of the first braking control device and by operation of the second braking control device, wherein
in order to carry out an automatic emergency braking process for the vehicle, the first braking control device interacts with a first evaluation unit (19), and the second braking control device interacts with a second evaluation unit (21), and wherein
the first evaluation unit (19) and the second evaluation unit (21) determine independently of one another whether the automatic emergency braking process should be carried out by operation of the respective braking control device, and the second evaluation unit (21) initiates the automatic emergency braking process when the first evaluation unit (19) and/or the first braking control device have/has a malfunction during operation,
characterized
in that the first evaluation unit (19) initiates the automatic emergency braking process only when the second evaluation unit (21) additionally determines that a predetermined additional initiation condition is satisfied.

2. The braking apparatus as claimed in claim 1,
characterized
in that the first braking control device is a service brake for the vehicle.

3. The braking apparatus as claimed in claim 1,
characterized
in that the second braking control device is a parking brake for the vehicle.

4. The braking apparatus as claimed in claim 1,
characterized
in that the first evaluation unit (19) and/or the first braking control device have/has a malfunction during operation when the first evaluation unit (19) initiates an automatic emergency braking process and the second evaluation unit (21) determines that the first evaluation unit (19) and/or the first braking control device is carrying out the automatic emergency braking process in an unintended manner.

5. The braking apparatus as claimed in claim 1,
characterized
in that the first evaluation unit (19) has a malfunction during operation when the second evaluation unit (21) determines, in contrast to the first evaluation unit (19), that the automatic emergency braking process should be carried out.

6. The braking apparatus as claimed in claim 1,
characterized
in that the first evaluation unit (19) determines on the basis of the satisfaction of at least one predetermined first initiation condition whether the automatic emergency braking process should be carried out.

7. The braking apparatus as claimed in claim 1,
characterized
in that the second evaluation unit (21) determines on the basis of the satisfaction of at least one predetermined second initiation condition whether the automatic emergency braking process should be carried out.

8. (canceled)

9. A braking method for a vehicle, wherein
the vehicle can be braked both by operation of a first braking control device (6, 8, 9, 10, 15, 27) and by operation of a second braking control device (7, 16, 17, 18), wherein
in order to carry out an automatic emergency braking process for the vehicle, the first braking control device interacts with a first evaluation unit (19), and the second braking control device interacts with a second evaluation unit (21), (19) and wherein
the first evaluation unit (19) and the second evaluation unit (21) determine independently of one another whether the automatic emergency braking process should be initiated by operation of the respective braking control device, and the second evaluation unit (21) initiates the automatic emergency braking process when the first evaluation unit (19) and/or the first braking control device have/has a malfunction during operations
characterized
in that the first evaluation unit (19) initiates the automatic emergency braking process only when the second evaluation unit (21) additionally determines that a predetermined additional initiation condition is satisfied.
